(19) United States
(12) Patent Application Publication
(10) Pub. No.: US 2026/0134616 A1
(43) Pub. Date: May 14, 2026

(54) Chaining Techniques for Ray Tracing Shaders

(71) Applicant: Apple Inc., Cupertino, CA (US)

(72) Inventors: Ali Rabbani Rankouhi, Bushey (GB); Luca O. Iuliano, Milton Keynes (GB); Richard J. Forster, San Jose, CA (US)

(21) Appl. No.: 18/971,551

(22) Filed: Dec. 6, 2024

Related U.S. Application Data
(60) Provisional application No. 63/696,452, filed on Sep. 19, 2024.

(51) Int. Cl. G06T 15/80; G06T 15/06

(52) U.S. Cl. CPC G06T 15/80; G06T 15/06

(57) ABSTRACT

Techniques are disclosed relating to leaf shaders for ray tracing in graphics processors. In some embodiments, a graphics processor includes shader processor circuitry and ray acceleration circuitry configured to perform traversal operations corresponding to an acceleration data structure for a graphics scene. The acceleration circuitry may, in response to traversal for a first ray reaching a node in the acceleration data structure, cause the shader processor circuitry to launch a first shader program to process the node. The processor may, in response to execution of an instruction included in the first shader program, launch and execute a second shader program to further process the node. Techniques are also disclosed for determining whether to generate a single shader or multiple chained shaders for a set of processing work.

The present application claims priority to U.S. Provisional App. No. 63/696,452, entitled “Chaining Techniques for Ray Tracing Shaders,” filed Sep. 19, 2024, the disclosure of which is incorporated by reference herein in its entirety.

### BACKGROUND

### Technical Field

This disclosure relates generally to graphics processors and more particularly to shader control techniques for ray tracing.

### Description of Related Art

In computer graphics, ray tracing is a rendering technique for generating an image by tracing the path of light as pixels in an image plane and simulating the effects of its encounters with virtual objects. Ray tracing may allow resolution of visibility in three dimensions between any two points in the scene, which is also the source of most of its computational expense. A typical ray tracer samples paths of light through the scene in the reverse direction of light propagation, starting from the camera and propagating into the scene, rather than from the light sources (this is sometimes referred to as “backward ray tracing”). Starting from the camera has the benefit of only tracing rays which are visible to the camera. This system can model a rasterizer, in which rays simply stop at the first surface and invoke a shader (analogous to a fragment shader) to compute a color. More commonly secondary effects—in which the exchange of illumination between scene elements, such as diffuse inter-reflection and transmission—are also modelled. Shaders that evaluate surface reflective properties may invoke further intersection queries (e.g., generate new rays) to capture incoming illumination from other surfaces. This recursive process has many formulations but is commonly referred to as path tracing.

Graphics processors that implement ray tracing typically provide more realistic scenes and lighting effects, relative to traditional rasterization systems. Ray tracing is typically computationally expensive, however. Improvements to ray tracing techniques may improve realism in graphics scenes, improve performance (e.g., allow tracing of more rays per frame, tracing in more complex scenes, or both), reduce power consumption (which may be particularly important in battery-powered devices), etc.

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a flow diagram illustrating an example method for chaining one or more subsequent shader programs to process a given node in a ray tracing acceleration data structure, according to some embodiments.

FIGS. 3A and 3B are diagrams that illustrate example split processing of leaf node data, according to some embodiments.

FIG. 4A is a diagram illustrating example parameters of a shader chaining instruction, according to some embodiments.

FIG. 4B illustrates example pseudocode with conditional use of a shader chaining instruction, according to some embodiments.

FIG. 5 is a diagram illustrating example ray binning for rays that utilize the same chained shader, according to some embodiments.

FIG. 6 is a diagram illustrating example communications, for shader chaining, between ray accelerator circuitry and shader core circuitry, according to some embodiments.

FIG. 7 is a flow diagram illustrating an example technique for determining whether to generate multiple chained shader programs, according to some embodiments.

FIG. 8 is a diagram illustrating example parallel tester hardware of ray accelerator circuitry, according to some embodiments.

FIG. 9 is a flow diagram illustrating an example method, according to some embodiments.

FIG. 10 is a block diagram illustrating an example computing device, according to some embodiments.

FIG. 11 is a diagram illustrating example applications of disclosed systems and devices, according to some embodiments.

FIG. 12 is a block diagram illustrating an example computer-readable medium that stores circuit design information, according to some embodiments.

### DETAILED DESCRIPTION

Ray tracing typically involves traversing an acceleration data structure (ADS) such as a bounding volume hierarchy (BVH) to determine a set of graphics primitives to test for intersection with a given ray. Hardware may accelerate various traversal operations but may launch shader programs to execute on a shader core in various scenarios. For example, ray intersection accelerator (RIA) hardware may traverse an ADS for a ray until it reaches a leaf node and then may launch a leaf shader program (which may also be referred to as a ray/primitive intersection shader) on the shader core. Shader programs are typically single-instruction multiple-thread (SIMT) programs. Therefore, the accelerator hardware may group multiple rays that reach the same leaf node into a leaf shader.

Certain ray tracing workloads often have threads diverge within a SIMT group. For example, in the context of curve tests, a leaf shader may first test a ray using a sequence of oriented bounding box (OBB) tests followed by a curve test. (Note that these tests may be in addition to hardware-accelerated axis-aligned bounding box (AABB) tests perform during traversal of the ADS before reaching a given leaf node). But, the OBB test may often fail such that a majority threads of a SIMT group are not active (e.g., predicated off) for the actual curve test. This means that the SIMT group may run at low efficiency and threads that are predicted off may incur the relatively long latency associated with the curve test.

Therefore, in disclosed embodiments, node processing (e.g., for a leaf node) is split into multiple chained shaders. For example, an initial shader may perform OBB test(s) and then execute a shader chaining instruction to launch a second shader to perform curve testing for rays that pass the OBB test(s). Thus, certain rays may be regathered and processed in chained shader(s) while other rays (e.g., that do not pass an OBB test) are able to independently continue their traversal (e.g., to find another leaf node to test). The ray accelerator hardware may facilitate launching one or more subsequent shaders (and may re-group rays for subsequent chained shaders).

Note that while various disclosed embodiments discuss pass/fail conditions for whether a SIMT thread launches a chained shader, there may be various other categories of conditions in other embodiments. For example, a test in an initial shader may have N possible outcomes and different outcomes may cause launching of up to M different chained shader programs for different threads (where M is less than or equal to N). In this context, some of the N outcomes may not cause a chained shader to launch.

### Graphics Processing Overview

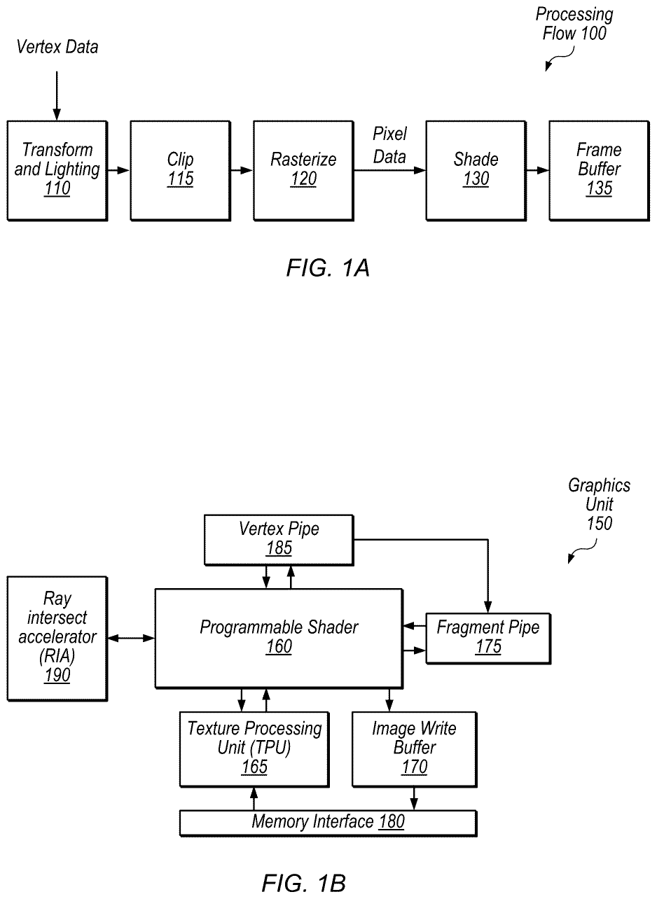

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

In the illustrated example, graphics unit 150 includes ray intersect accelerator (RIA) 190, which may include hardware configured to perform various ray intersect operations (e.g., for traversal of a bounding volume hierarchy acceleration data structure) in response to instruction(s) executed by programmable shader 160, as described in detail below.

### Overview of Shader Chaining

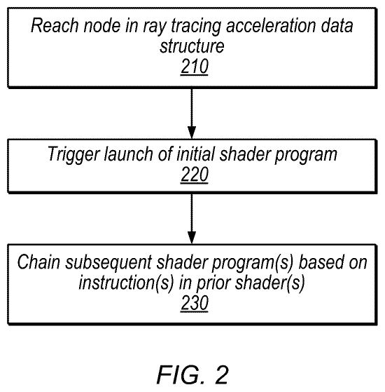

FIG. 2 is a flow diagram illustrating an example method for chaining one or more subsequent shader programs to process a given node in a ray tracing acceleration data structure, according to some embodiments. At 210, ray intersect accelerator 190 reaches a node in a ray tracing acceleration data structure. The node may be reached during a depth-first traversal of a BVH, for example.

In some embodiments, disclosed techniques are applied only to leaf nodes, e.g., where a leaf node indicates a set of one or more primitives that are included within an axis-aligned bounding box associated with the leaf node. In other embodiments, disclosed shader chaining techniques may be applied to other types of nodes as well, e.g., instance nodes that specify a coordinate transform and whose corresponding operations may be split between multiple shaders.

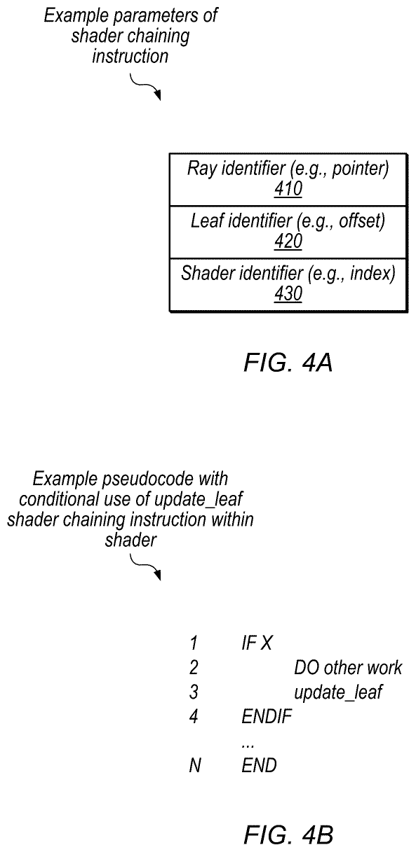

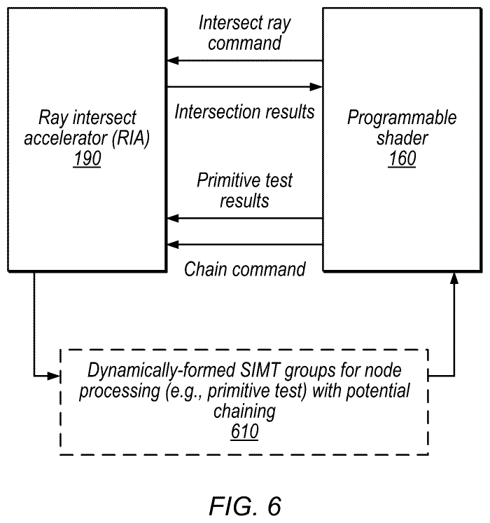

At 220, in the illustrated embodiment, ray intersect accelerator 190 triggers launch of an initial shader program, e.g., to execute on programmable shader 160. The initial shader program may include one or more shader chaining instructions. One example of a shader chaining instruction is an update_leaf instruction, which is discussed in more detail below with reference to FIGS. 4A-4B. FIG. 6 also provides more details regarding communications between ray accelerator hardware and a shader core for initiating shader programs.

At 230, in the illustrated embodiment, the system chains one or more subsequent shader programs based on instruction(s) in prior shaders (e.g., the initial shader, one or more chained shaders, or both). Generally, multiple levels of chaining may be supported, although some embodiments may enforce a limit on chaining levels. In some embodiments, RIA 190 triggers launch of the chained shader programs (e.g., because it has access to ray data associated with further processing of the node by the chained shaders and includes control circuitry to re-gather rays that proceed to a chained shader).

Note that the chaining of 230 may be performed based on execution of the initial shader program for a node and not based on other traversal operations relating to the ADS. Therefore, the shader chaining may occur for processing of a single node (e.g., a leaf node). Further, conditions on whether a shader is chained may be evaluated by the initial shader program rather than by intersection hardware (e.g., based on execution of conditional instructions in the shader). Further, the initial shader and the chained shader(s) may be the same type of shader, e.g., all leaf shaders, all transform shaders, etc.

### Example Split Processing of Leaf Node for Curve Test

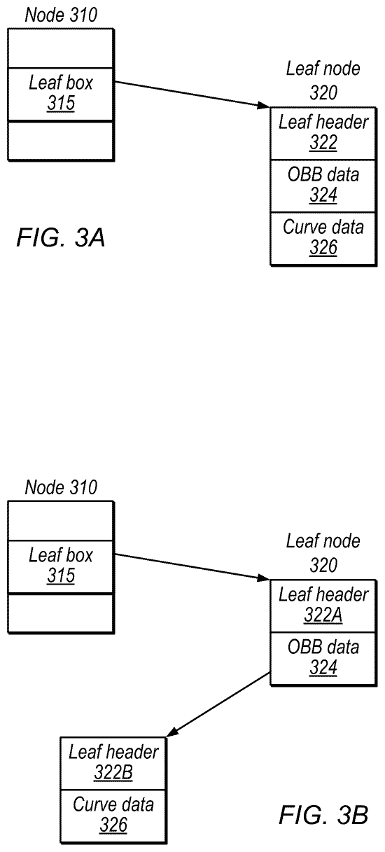

FIGS. 3A and 3B are diagrams that illustrate example split processing of leaf node data, according to some embodiments. FIG. 3A illustrates a parent node 310 that defines a leaf box corresponding to leaf node 320 (for example, the leaf box may have a defined spatial relationship with any primitives associated with the leaf node). In response to detecting intersection of a ray with leaf box 315, RIA 190 may traverse to leaf node 320. In the illustrated example, leaf node 320 includes a leaf header 322, OBB data 324, and curve data 326. According to traditional techniques, one leaf shader may process both the OBB data and the curve data.

FIG. 3B illustrates an example splitting of the leaf node data into the OBB data 324 and curve data 326, which separate headers for each (322A and 322B). This may facilitate chained processing of the leaf node. For example, a chained shader may conditionally execute if the ray intersects box(es) represented by the OBB data 324 and access leaf header 322B to appropriately process the curve data 326 and perform one or more curve tests.

Generally, the implementation of FIG. 3B may be processed as a single leaf node with split data. In other embodiments, this implementation may be processed as two leaf nodes, but the initial shader and chained shader(s) may still operate on the same set of leaf data that is split over multiple leaf nodes (e.g., coordinate data associated with testing for intersection with one or more primitives). Note that the split leaf nodes may correspond to the same primitive or set of primitives and non-initial leaves in such a set of leaf nodes may be reachable only via the initial leaf node in the set.

### Example Shader Chaining Instruction

FIG. 4A is a diagram illustrating example parameters of a shader chaining instruction, according to some embodiments. In this illustrated example, the shader chaining instruction encodes ray identifier 410, leaf identifier 420, and shader identifier 430. In some embodiments, all three fields are passed in a token buffer identified by the shader chaining instruction. The token buffer may be stored in a shader core space that is accessible to both ray intersect accelerator 190 and programmable shader 160. The shader chaining instruction may identify the token buffer using a pointer into the shader core space or by identifying a register that stores a pointer into the shader core space, for example. The output addresses for one or more fields within the token buffer may be determined based on the thread identifier for the corresponding thread of a SIMT group (where different threads of the SIMT group execute the leaf shader for different rays).

Ray identifier 410, in some embodiments, identifies the ray for which traversal of the ADS is being performed and for which additional processing for the leaf node should be performed. In some embodiments, the ray identifier 410 is a pointer to ray data. The ray data may indicate various ray attributes, such as origin coordinates, direction information, a parametric time value, etc. The ray information may be sufficient to perform various test operations associated with the leaf node.

Leaf identifier 420, in some embodiments, identifies the leaf node for which chained processing is to occur. This may be the same leaf node that the current shader (that includes the shader chaining instruction) is currently processing. The leaf identifier 420 may be an offset, e.g., within the acceleration data structure to access data for the leaf. In embodiment with a split header as shown in FIG. 3B, the offset may indicate leaf header 322B.

Shader identifier 430, in some embodiments, identifies the chained shader to be launched. The shader identifier 430 may be an index into a shader table, for example. The shader index may be based on address mode and leaf variant parameters.

FIG. 4B illustrates example pseudocode with conditional use of a shader chaining instruction, according to some embodiments. In this example, the code of the initial shader conditionally calls the shader chaining instruction or not for a given thread.

Line 1 is an “IF” instruction that evaluates a condition X. IF the condition is true, code corresponding to lines 2-3 is executed, otherwise it is skipped. Line 2 represents one or more other instructions for other processing work, followed by an update_leaf instruction (one example of a shader chaining instruction). If the condition is not true at line 1, execution proceeds to lines after the ENDIF at line 4 and the shader does not execute a shader chaining instruction. For example, if the condition relates to whether the ray intersected one or more OBBs, a chained shader with a curve test may not be executed if the one or more OBB tests fail.

In some embodiments the system imposes a limit on the number of shader chaining instructions in a given shader. In some embodiments, this limit is one, although greater limits may be implemented in other embodiments. As mentioned above, some initial shaders may have multiple possible conditional outcomes and launch different chained shaders for different threads (or refrain from launching a chained shader for some threads) depending on the outcome. For example, such conditions may be implemented using sequential if/elseif/else statements, a switch/case statement, etc. (with shader chaining instructions in different code blocks to launch different shaders depending on which condition evaluates as true). In this context, threads that execute the same chained shader may be grouped, as discussed in the following section.

### Example Ray Binning

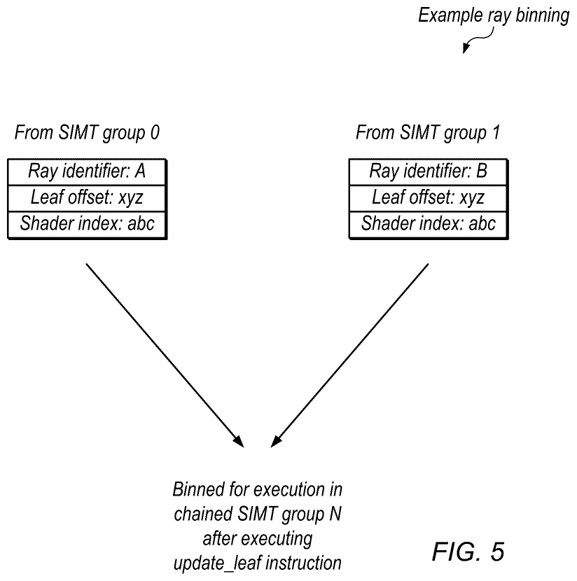

FIG. 5 is a diagram illustrating example ray binning for rays that utilize the same chained shader, according to some embodiments. For example, multiple SIMT groups may execute ray chaining instructions that identify the same leaf node and shader (e.g., in fields 420 and 430). In some embodiments, ray intersect accelerator 190 is configured to bin multiple such rays from different SIMT groups into the same chained SIMT group.

In the example of FIG. 5, ray A from SIMT group 0 and ray B from SIMT group 1 are both associated with an executed ray chaining instruction in their respective SIMT group. In this example, both rays specify the same leaf offset “xyz” and shader index “abc.” Therefore, these two rays are binned for execution in the same chained SIMT group N after executing the update_leaf instruction. These rays may then be processed by different threads of SIMT group N. This may advantageously provide efficient use of shader resources, e.g., by keeping threads of SIMT groups active (particularly relative to non-chained implementations in which threads may remain predicated off for the operations corresponding to the chained shader). This may in turn improve performance, reduce power consumption, or both.

Note that binning circuitry may be used both for binning rays for the initial leaf shader and for re-binning rays for a chained shader. Therefore, the set of rays processed by the chained shader may different from the set of rays processed by the initial leaf shader (and may include rays from multiple different initial leaf shaders that process the same leaf node). Binning circuitry may include tag and comparison circuitry, for example, to gather rays with various matching attributes.

In some embodiments, control circuitry is configured to bin rays into a SIMT group for a chained shader until the SIMT group is full or until a timeout interval has occurred (at which point the control circuitry may initiate execution of a non-full chained SIMT group).

### Example Hardware Implementations and Decision Whether to Split Shader Functionality

FIG. 6 is a diagram illustrating example communications between ray accelerator circuitry and shader core circuitry, for shader chaining, according to some embodiments. In some embodiments, utilizing the ray accelerator circuitry to facilitate launching chained shaders may be advantageous, e.g., because ray intersect accelerator 190 may already include control circuitry configured to launch various types of shaders (e.g., transform shaders and leaf shaders) and perform auxiliary tasks such as binning to group rays into SIMT shaders.

In the illustrated example, programmable shader 160 receives and executes an intersect ray instruction included in a graphics program. The intersect ray instruction may be a SIMT instruction, for example, and may specify different rays for different threads. In response, programmable shader 160 sends an intersect ray command to RIA 190. The command may include a pointer to a data structure for a given ray being processed.

RIA 190, in the illustrated example, is configured to produce intersection results based on traversal of a spatially organized data structure for the scene (e.g., based on intersection tests with axis-aligned bounding boxes of a BVH). RIA 190 includes bounding region test circuitry, which may be configured to test a ray against multiple bounding regions (e.g., boxes) in parallel. In some embodiments, the intersection results indicate a set of primitives to be tested for intersection based on reaching a leaf node, e.g., RIA 190 may dynamically launch one or more SIMT groups (shown at 610) to execute on the programmable shader 160 for primitive testing. As shown, programmable shader 160 may provide primitive tests results, which may result in further traversal operations (e.g., additional traversal operations for an “any-hit” ray for which no primitive intersections were found).

In embodiments with shader chaining, shader 160 is configured to send a chain command to RIA 190 in response to executing a shader chaining instruction (e.g., an update_leaf instruction). RIA 190 may dynamically form and launch SIMT groups (e.g., a portion of the groups shown at 610) for additional node processing in response to such a chain command. The chain command may include all or a portion of the information encoded by the executed shader chaining instruction.

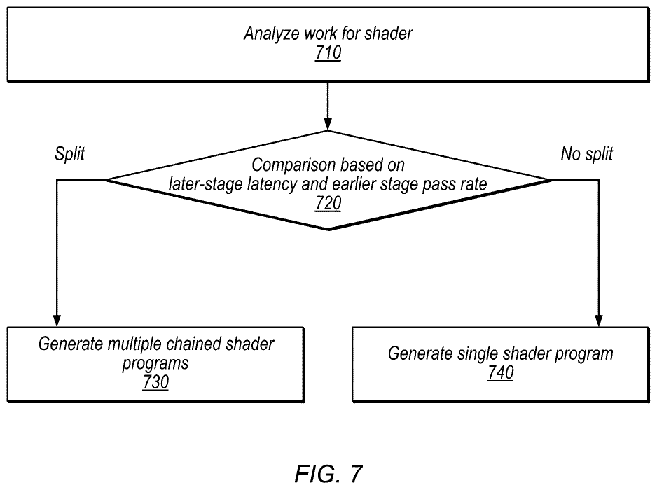

FIG. 7 is a flow diagram illustrating an example technique for determining whether to generate multiple chained shader programs, according to some embodiments. The method of claim 7 may be performed by a compiler, for example.

At 710, in the illustrated example, the system analyzes work for a shader (e.g., a leaf shader). This may include estimating latency or processing time for different portions of the shader. It may also include estimating pass rate for different stages of the shader (e.g., how many threads in a SIMT group are expected to actually execute later stages of the shader), which may be based on model workloads, for example. It may also include estimating shader launch latency, which may be based on knowledge of hardware architecture of the GPU, parameters of the shader, or some combination thereof.

At 720, in the illustrated example, the system performs a comparison based on estimated later-stage latency for one or more non-initial stages and the pass rate of one or more earlier stages. For a given set of stages, element 720 may dictate whether to split the stages into different shaders by generating multiple chained shader programs at 730 (e.g., by inserting shader chaining instructions into one or more shaders) or keep them in a single shader (e.g., by generating a single shader program at 740). The system may appropriately insert the single or chained shaders into a shader index table.

In some embodiments, a rough formula for determining whether to split a shader with two distinct stages is as follows, where a “true” evaluation of the equation indicates that the shader should be split:

$$second\_stage \_latency > shader\_launch \_latency * ( first\_stage \_pass \_rate / first\_stage \_fail \_rate )$$

Various appropriate algorithms may be utilized in other embodiments, however, to potentially split shader work into N chained shaders.

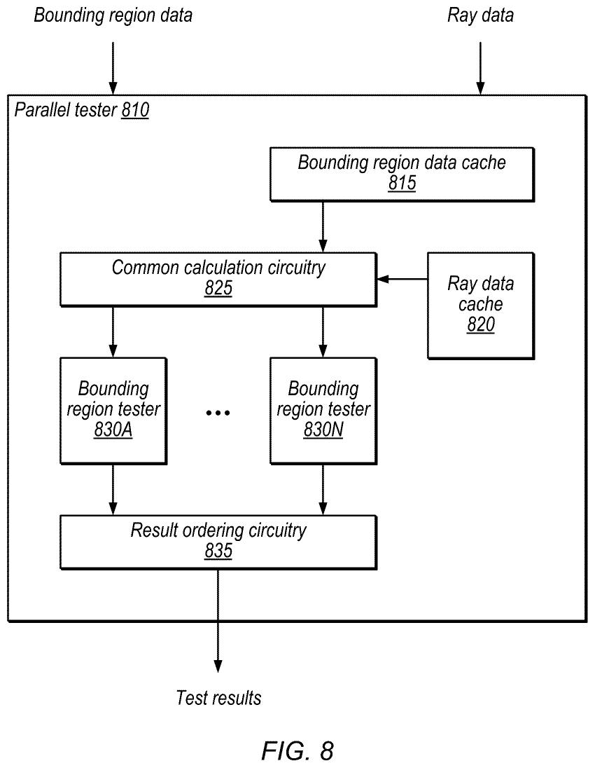

FIG. 8 is a diagram illustrating example parallel tester hardware of ray accelerator circuitry, according to some embodiments. In the illustrated example, parallel tester circuitry 810 receives ray data and bounding region data for multiple bounding regions and outputs results indicating whether a ray intersected the bounding regions. Parallel tester 810 includes bounding region data cache 815, ray data cache 820, common calculation circuitry 825, bounding region testers 830A-830N, and result ordering circuitry 835.

In some embodiments, parallel tester 810 is a node tester configured to test up to N bounding regions, where each node in the ADS includes up to N child nodes. RIA 190 may include multiple parallel testers 810, e.g., 2, 4, 8, etc. for each programmable shader, in embodiments with M programmable shader instances. In these embodiments, each node tester may test up to N nodes per clock, per programmable shader core. In some embodiments (e.g., for example depth-first traversals discussed herein), a given ray is tested against at most one node at a time.

Bounding region data cache 815 and ray data cache 820, in some embodiments, are configured to store node and ray data respectively for the current test and for potential re-use in subsequent tests. These caches may be able to sustain a throughput corresponding to a node test per clock per tester. For tests to occur, both ray and bounding region information may be needed, so cache entries may be locked for reading until both pieces of information are available. In some embodiments, grouping rays that target the same next node may improve performance of the caches and reduce bandwidth to a higher-level cache. The grouping control circuitry may similarly be used for rays that reach the same leaf node to form an initial leaf shader and potentially to form chained shaders.

Common calculation circuitry 825, in some embodiments, is configured to perform calculations that are common to all bounding regions being tested. This may include determining bounds represented using a compressed quantized format. As another example, this may include common ray calculations such as determining a reciprocal of the ray and a test point of the ray. In some embodiments, common calculations are performed at a higher floating-point precision than bounding region tests.

Bounding region testers 830, in some embodiments, are configured to test whether a ray intersects a representation of a bounding region (note that false positives may be included in embodiments with quantization, however). For box-shaped bounding regions, these testers may implement a slab test (e.g., finding the distance of each ray to the six sides of each box and comparing those values to determine whether the ray has hit in the box or not). Generally, bounding region testers 830 may include circuitry configured to perform arithmetic operations associated with the type of testing implemented and this circuitry may be pipelined. In some embodiments, bounding region testers 830 utilize lower-precision floating point arithmetic and choose rounding modes such that the calculated intersection results for the three planes facing the ray round down (towards the ray) and the intersection results for the three opposite planes facing away round up (away from the ray) to ensure that the bounding region test is conservative and does not yield false negatives.

Result ordering circuitry 835, in some embodiments, is configured to order hit results (e.g., based on their distance to the origin of the ray) and output the results for use in further traversal. Therefore, non-leaf children may be pushed onto the stack based on this ordering. In some embodiments, any leaf children may be grouped into a single stack entry. In some embodiments, the ordering may affect traversal of the ADS, e.g., child nodes corresponding to closer hits may be traversed first during a depth-first search.

In some embodiments, parallel tester circuitry 810 is configured to save the value of the parametric internal (T) parameter at which a ray intersects a bounding region (and may save the value at a higher precision than the plane tests). This value may be referred to as T-local and may be saved in stack entries and retrieved for use as the numerical ray origin for child bounding region plane tests.

In some embodiments, multiple rays may be tested in parallel against the same node, a ray may be tested in parallel against multiple nodes, or both. For example, RIA 190 may include multiple parallel testers 810 to process all or a portion of the rays in a group of rays in parallel. In some embodiments, each bounding region tester 830 may be configured to test multiple rays against a bounding region in parallel.

### Example Method

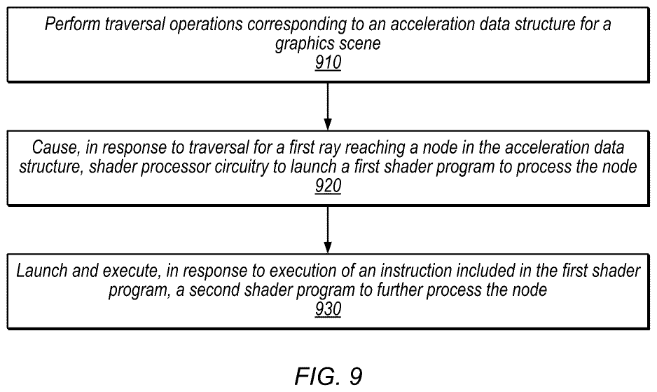

FIG. 9 is a flow diagram illustrating an example method, according to some embodiments. The method shown in FIG. 9 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 910, in the illustrated embodiment, a computing system (e.g., ray intersect accelerator 190) performs traversal operations corresponding to an acceleration data structure for a graphics scene.

At 920, in the illustrated embodiment, the computing system, (e.g., ray intersect accelerator 190) causes, in response to traversal for a first ray reaching a node in the acceleration data structure, shader processor circuitry (e.g., programmable shader 160) to launch a first shader program to process the node.

At 930, in the illustrated embodiment, the computing system (e.g., ray intersect accelerator 190 and programmable shader 160) launches and executes, in response to execution of an instruction included in the first shader program, a second shader program to further process the node.

In some embodiments, the shader processor circuitry is configured to issue a shader chain command to the ray acceleration circuitry in response to execution of the instruction and the ray acceleration circuitry is configured to cause the shader processor circuitry to launch the second shader program based on the shader chain command (e.g., as discussed with reference to FIG. 6).

In some embodiments, the instruction identifies the node, the second shader program, and the first ray. In some embodiments, the instruction includes a pointer to a token buffer that stores various instruction parameters. In some embodiments, the first shader program includes one or more conditional instructions that control whether the instruction is executed.

In some embodiments, the node is a leaf node and the first shader program and the second shader program are both leaf shaders. In some embodiments, the first shader program is executable to perform an oriented bounding box intersection test and the second shader program is executable to perform a curve test. The shaders may be stored in storage circuitry of the system (e.g., indexed according to a shader table).

In some embodiments, bin circuitry groups multiple rays that reach the node for processing by a single-instruction multiple thread (SIMT) group corresponding to the first shader program. In some embodiments, the bin circuitry also group multiple rays from different SIMT groups that execute the instruction into the threads of the second shader program. For example, RIA 190 may bin rays both for initial leaf shaders and for chained shaders, and the groups of rays for the chained shaders may vary from the initial leaf shaders.

In some embodiments, the node is a transform node. For example, the initial shader may perform one portion of a transform operation and a chained shader perform a second portion.

In some embodiments, a computing system generates a first shader program (e.g., an initial leaf shader) and control information that specifies to launch the first shader program in response to a ray reaching a node during traversal of a ray tracing acceleration data structure. In some embodiments, the computing system also generates a second shader program and inserts an instruction in the first shader program (e.g., a shader chaining instruction) that specifies to launch and execute the second shader program to perform additional processing of the node. The computing system may determine whether to generate a single shader program for a set of work or to generate the first and second shader programs for the set of work based on: an expected ratio of threads expected to execute work corresponding to the second shader program and an expected execution time of the work corresponding to the second shader program.

The concept of “execution” is broad and may refer to 1) processing of an instruction throughout an execution pipeline (e.g., through fetch, decode, execute, and retire stages) and 2) processing of an instruction at an execution unit or execution subsystem of such a pipeline (e.g., an integer execution unit or a load-store unit). The latter meaning may also be referred to as “performing” the instruction. Thus, “performing” an add instruction refers to adding two operands to produce a result, which may, in some embodiments, be accomplished by a circuit at an execute stage of a pipeline (e.g., an execution unit). Conversely, “executing” the add instruction may refer to the entirety of operations that occur throughout the pipeline as a result of the add instruction. Similarly, “performing” a “load” instruction may include retrieving a value (e.g., from a cache, memory, or stored result of another instruction) and storing the retrieved value into a register or other location.

As used herein the terms “complete” and “completion” in the context of an instruction refer to commitment of the instruction's result(s) to the architectural state of a processor or processing element. For example, completion of an add instruction includes writing the result of the add instruction to a destination register. Similarly, completion of a load instruction includes writing a value (e.g., a value retrieved from a cache or memory) to a destination register or a representation thereof.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

For a given program or portion of a program, flow typically proceeds in a sequential fashion. Consider the following group of instructions: ld mem1→r1; add r1, r2→r3; st r3→mem2. In this exemplary sequence, execution and completion proceeds sequentially from the load instruction to the add instruction to the store instruction. This sequential ordering can be considered the program flow default. In this example, none of these instructions affects the selection of the next instruction to be executed and completed (beyond the default behavior).

In contrast, the execution and completion of instructions with certain opcodes potentially affects the selection of the next instruction to be executed and completed. These instructions are referred to herein as “control transfer instructions.” Control transfer instructions may include, without limitation, branches, jumps, calls, returns, etc. Instructions of these types can cause a change in the default behavior of the next instruction to be executed and completed. Control transfer instructions may be used, for example, to execute a loop of instructions.

There may also be many different types of control transfer instructions. For example, control transfer instructions may operate conditionally (i.e., setting the program counter based on whether some condition is true or false) or unconditionally. Similarly, certain control transfer instructions may specify direct target addresses; other control transfer instructions may specify indirect target addresses. Note that the execution and completion of control transfer instructions may have effects on processor state other than on the location of the next instruction (e.g., there might be an instruction that branches after performing an arithmetic operation).

### Example Device

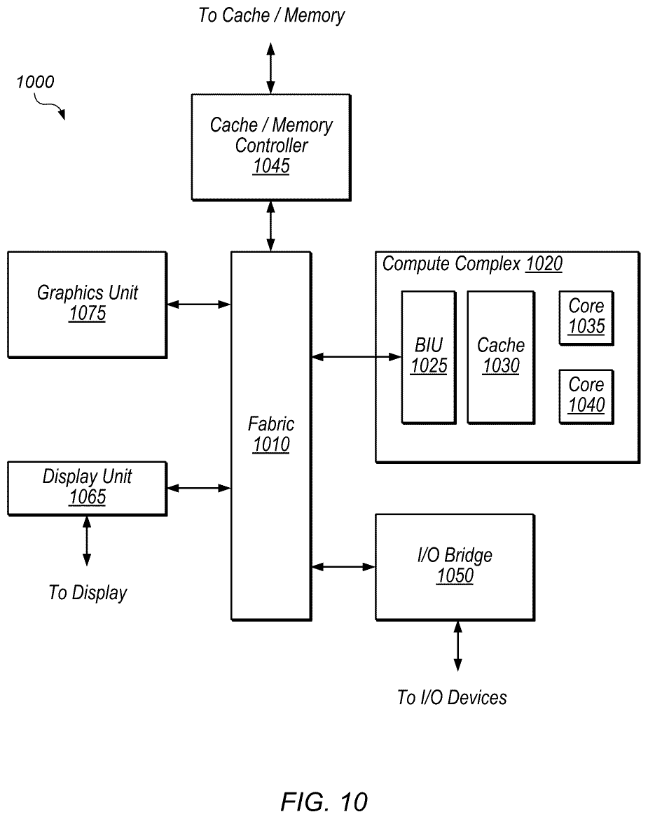

Referring now to FIG. 10, a block diagram illustrating an example embodiment of a device 1000 is shown. In some embodiments, elements of device 1000 may be included within a system on a chip. In some embodiments, device 1000 may be included in a mobile device, which may be battery-powered. Therefore, power consumption by device 1000 may be an important design consideration. In the illustrated embodiment, device 1000 includes fabric 1010, compute complex 1020 input/output (I/O) bridge 1050, cache/memory controller 1045, graphics unit 1075, and display unit 1065. In some embodiments, device 1000 may include other components (not shown) in addition to or in place of the illustrated components, such as video processor encoders and decoders, image processing or recognition elements, computer vision elements, etc.

Fabric 1010 may include various interconnects, buses, MUX's, controllers, etc., and may be configured to facilitate communication between various elements of device 1000. In some embodiments, portions of fabric 1010 may be configured to implement various different communication protocols. In other embodiments, fabric 1010 may implement a single communication protocol and elements coupled to fabric 1010 may convert from the single communication protocol to other communication protocols internally.

In the illustrated embodiment, compute complex 1020 includes bus interface unit (BIU) 1025, cache 1030, and cores 1035 and 1040. In various embodiments, compute complex 1020 may include various numbers of processors, processor cores and caches. For example, compute complex 1020 may include 1, 2, or 4 processor cores, or any other suitable number. In one embodiment, cache 1030 is a set associative L2 cache. In some embodiments, cores 1035 and 1040 may include internal instruction and data caches. In some embodiments, a coherency unit (not shown) in fabric 1010, cache 1030, or elsewhere in device 1000 may be configured to maintain coherency between various caches of device 1000. BIU 1025 may be configured to manage communication between compute complex 1020 and other elements of device 1000. Processor cores such as cores 1035 and 1040 may be configured to execute instructions of a particular instruction set architecture (ISA) which may include operating system instructions and user application instructions. These instructions may be stored in computer readable medium such as a memory coupled to memory controller 1045 discussed below.

As used herein, the term “coupled to” may indicate one or more connections between elements, and a coupling may include intervening elements. For example, in FIG. 10, graphics unit 1075 may be described as “coupled to” a memory through fabric 1010 and cache/memory controller 1045. In contrast, in the illustrated embodiment of FIG. 10, graphics unit 1075 is “directly coupled” to fabric 1010 because there are no intervening elements.

Cache/memory controller 1045 may be configured to manage transfer of data between fabric 1010 and one or more caches and memories. For example, cache/memory controller 1045 may be coupled to an L3 cache, which may in turn be coupled to a system memory. In other embodiments, cache/memory controller 1045 may be directly coupled to a memory. In some embodiments, cache/memory controller 1045 may include one or more internal caches. Memory coupled to controller 1045 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1045 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1020 to cause the computing device to perform functionality described herein.

Graphics unit 1075 may include one or more processors, e.g., one or more graphics processing units (GPUs). Graphics unit 1075 may receive graphics-oriented instructions, such as OPENGL®, Metal®, or DIRECT3D® instructions, for example. Graphics unit 1075 may execute specialized GPU instructions or perform other operations based on the received graphics-oriented instructions. Graphics unit 1075 may generally be configured to process large blocks of data in parallel and may build images in a frame buffer for output to a display, which may be included in the device or may be a separate device. Graphics unit 1075 may include transform, lighting, triangle, and rendering engines in one or more graphics processing pipelines. Graphics unit 1075 may output pixel information for display images. Graphics unit 1075, in various embodiments, may include programmable shader circuitry which may include highly parallel execution cores configured to execute graphics programs, which may include pixel tasks, vertex tasks, and compute tasks (which may or may not be graphics-related).

Disclosed techniques may advantageously improve resources utilization of graphics unit 1075 (e.g., of SIMT execution pipelines) which may improve performance, reduce power consumption for a given workload, etc.

Display unit 1065 may be configured to read data from a frame buffer and provide a stream of pixel values for display. Display unit 1065 may be configured as a display pipeline in some embodiments. Additionally, display unit 1065 may be configured to blend multiple frames to produce an output frame. Further, display unit 1065 may include one or more interfaces (e.g., MIPI® or embedded display port (eDP)) for coupling to a user display (e.g., a touchscreen or an external display).

I/O bridge 1050 may include various elements configured to implement: universal serial bus (USB) communications, security, audio, and low-power always-on functionality, for example. I/O bridge 1050 may also include interfaces such as pulse-width modulation (PWM), general-purpose input/output (GPIO), serial peripheral interface (SPI), and inter-integrated circuit (I2C), for example. Various types of peripherals and devices may be coupled to device 1000 via I/O bridge 1050.

In some embodiments, device 1000 includes network interface circuitry (not explicitly shown), which may be connected to fabric 1010 or I/O bridge 1050. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1000 with connectivity to various types of other devices and networks.

### Example Applications

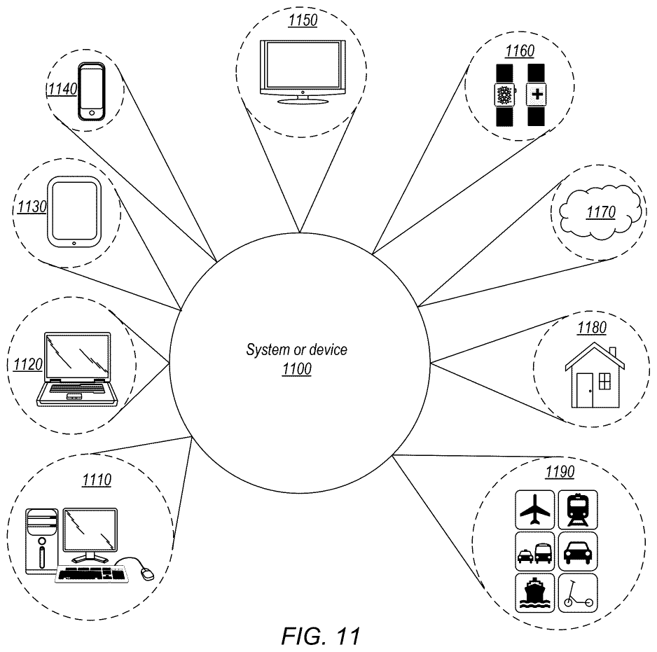

Turning now to FIG. 11, various types of systems that may include any of the circuits, devices, or system discussed above. System or device 1100, which may incorporate or otherwise utilize one or more of the techniques described herein, may be utilized in a wide range of areas. For example, system or device 1100 may be utilized as part of the hardware of systems such as a desktop computer 1110, laptop computer 1120, tablet computer 1130, cellular or mobile phone 1140, or television 1150 (or set-top box coupled to a television).

Similarly, disclosed elements may be utilized in a wearable device 1160, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1100 may also be used in various other contexts. For example, system or device 1100 may be utilized in the context of a server computer system, such as a dedicated server or on shared hardware that implements a cloud-based service 1170. Still further, system or device 1100 may be implemented in a wide range of specialized everyday devices, including devices 1180 commonly found in the home such as refrigerators, thermostats, security cameras, etc. The interconnection of such devices is often referred to as the “Internet of Things” (IoT). Elements may also be implemented in various modes of transportation. For example, system or device 1100 could be employed in the control systems, guidance systems, entertainment systems, etc. of various types of vehicles 1190.

The applications illustrated in FIG. 11 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

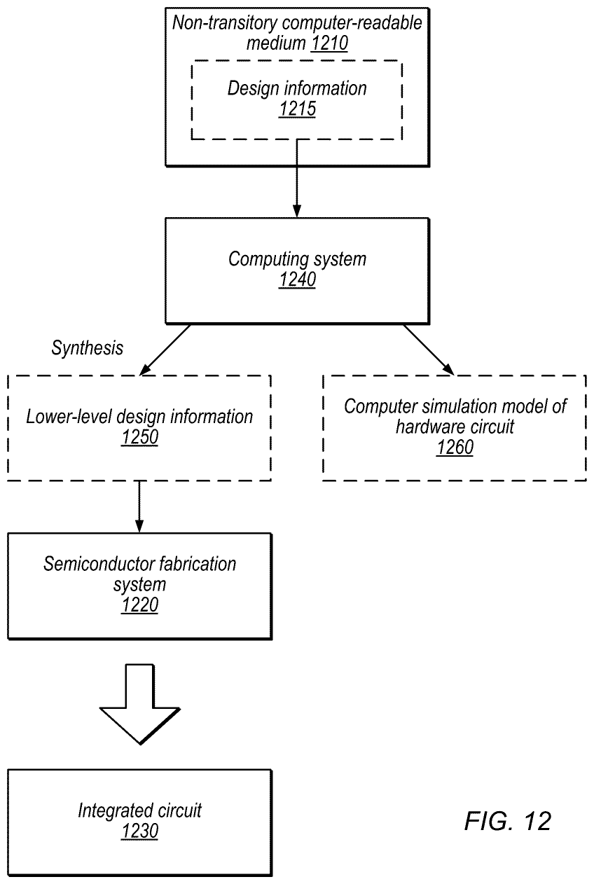

FIG. 12 is a block diagram illustrating an example non-transitory computer-readable storage medium that stores circuit design information, according to some embodiments. In the illustrated embodiment, computing system 1240 is configured to process the design information. This may include executing instructions included in the design information, interpreting instructions included in the design information, compiling, transforming, or otherwise updating the design information, etc. Therefore, the design information controls computing system 1240 (e.g., by programming computing system 1240) to perform various operations discussed below, in some embodiments.

In the illustrated example, computing system 1240 processes the design information to generate both a computer simulation model of a hardware circuit 1260 and lower-level design information 1250. In other embodiments, computing system 1240 may generate only one of these outputs, may generate other outputs based on the design information, or both. Regarding the computing simulation, computing system 1240 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1240 also processes the design information to generate lower-level design information 1250 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1250 (potentially among other inputs), semiconductor fabrication system 1220 is configured to fabricate an integrated circuit 1230 (which may correspond to functionality of the simulation model 1260). Note that computing system 1240 may generate different simulation models based on design information at various levels of description, including information 1250, 1215, and so on. The data representing design information 1250 and model 1260 may be stored on medium 1210 or on one or more other media.

In some embodiments, the lower-level design information 1250 controls (e.g., programs) the semiconductor fabrication system 1220 to fabricate the integrated circuit 1230. Thus, when processed by the fabrication system, the design information may program the fabrication system to fabricate a circuit that includes various circuitry disclosed herein.

Non-transitory computer-readable storage medium 1210, may comprise any of various appropriate types of memory devices or storage devices. Non-transitory computer-readable storage medium 1210 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1210 may include other types of non-transitory memory as well or combinations thereof. Accordingly, non-transitory computer-readable storage medium 1210 may include two or more memory media; such media may reside in different locations—for example, in different computer systems that are connected over a network.

Design information 1215 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1240, semiconductor fabrication system 1220, or both. In some embodiments, design information may also include one or more cell libraries that specify the synthesis, layout, or both of integrated circuit 1230. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1230 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1220 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1220 may also be configured to perform various testing of fabricated circuits for correct operation.

In various embodiments, integrated circuit 1230 and model 1260 are configured to operate according to a circuit design specified by design information 1215, which may include performing any of the functionality described herein. For example, integrated circuit 1230 may include any of various elements shown in FIGS. 1B, 6, 8, and 10. Further, integrated circuit 1230 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1220 to fabricate integrated circuit 1230.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
a graphics processor that includes:
shader processor circuitry; and
ray acceleration circuitry configured to:
perform traversal operations corresponding to an acceleration data structure for a graphics scene; and
in response to traversal for a first ray reaching a node in the acceleration data structure, cause the shader processor circuitry to launch a first shader program to process the node;
wherein the graphics processor is configured to, in response to execution of an instruction included in the first shader program, launch and execute a second shader program to further process the node.

2. The apparatus of claim 1, wherein the node is a leaf node and the first shader program and the second shader program are both leaf shaders.

3. The apparatus of claim 1, further comprising:
storage circuitry configured to store the first shader program and the second shader program, wherein:
the first shader program is executable to perform an oriented bounding box intersection test; and
the second shader program is executable to perform a curve test.

4. The apparatus of claim 1, wherein:
the shader processor circuitry is configured to issue a shader chain command to the ray acceleration circuitry in response to execution of the instruction; and
the ray acceleration circuitry is configured to cause the shader processor circuitry to launch the second shader program based on the shader chain command.

5. The apparatus of claim 1, wherein the instruction identifies:
the node; and
the second shader program.

6. The apparatus of claim 5, wherein the instruction further identifies the first ray.

7. The apparatus of claim 5, wherein the instruction includes a pointer to a token buffer that identifies the node and the second shader program.

8. The apparatus of claim 1, wherein the first shader program includes one or more conditional instructions that control whether the instruction is executed.

9. The apparatus of claim 1, further comprising:
bin circuitry configured to:
group multiple rays that reach the node for processing by a single-instruction multiple thread (SIMT) group corresponding to the first shader program; and
group multiple rays from different SIMT groups that execute the instruction into the threads of the second shader program.

10. The apparatus of claim 1, wherein the node is a transform node.

11. The apparatus of claim 1, wherein the apparatus is a computing device that further includes:
a central processing unit;
a display; and
network interface circuitry.

12. A method, comprising:
performing, by ray acceleration hardware of a computing system, traversal operations corresponding to an acceleration data structure for a graphics scene;
causing, by the ray acceleration hardware in response to traversal for a first ray reaching a node in the acceleration data structure, a processor of the computing system, to launch a first shader program to process the node; and
launching and executing, by the processor in response to execution of an instruction included in the first shader program, a second shader program to further process the node.

13. The method of claim 12, wherein the node is a leaf node and the first shader program and the second shader program are both leaf shaders.

14. The method of claim 12, wherein:
the first shader program performs an oriented bounding box intersection test; and
the second shader program performs a curve test.

15. The method of claim 12, wherein the instruction identifies:
the node; and
the second shader program.

16. The method of claim 15, wherein the instruction further identifies the first ray.

17. The method of claim 12, wherein the first shader program is a single-instruction multiple-thread (SIMT) program and only a proper subset of threads of the SIMT program execute the instruction.

18. The method of claim 12, further comprising:
binning, by the ray acceleration hardware, multiple rays from different SIMT groups that execute the instruction for the first shader program into SIMT threads of the second shader program.

19. A non-transitory computer-readable medium having instructions stored thereon that are executable by a computing device to perform operations comprising:
generating a first shader program and control information that specifies to launch the first shader program in response to a ray reaching a node during traversal of a ray tracing acceleration data structure; and
generating a second shader program;
wherein the generating the first shader program includes inserting an instruction in the first shader program that specifies to launch and execute the second shader program to perform additional processing of the node.

20. The non-transitory computer-readable medium of claim 19, wherein the operations further comprise:
determining whether to generate a single shader program for a set of work or to generate the first and second shader programs for the set of work based on:
an expected ratio of threads expected to execute work corresponding to the second shader program; and
an expected execution time of the work corresponding to the second shader program.
